(19) United States
(12) Patent Application Publication
(10) Pub. No.: US 2017/0239628 A1
(43) Pub. Date: Aug. 24, 2017

(54) Low Energy Aeration

(71) Applicant: John Paul Archibald, Annandale, VA (US)

(72) Inventor: John Paul Archibald, Annandale, VA (US)

(21) Appl. No.: 15/048,991

(22) Filed: Feb. 19, 2016

(51) Int. Cl. B01F 3/04; C02F 3/20

(52) U.S. Cl. CPC B01F 3/04255; C02F 3/20; B01F 2003/04319

(57) ABSTRACT

A low energy apparatus to aerate liquid in a tank using pumped liquid flow over bubble aerators operating at low air pressure near the tank surface, with the flow of liquid and entrained bubbles then being directed through pipes at speeds sufficient to carry the bubbles to the bottom of the tank where the bubbles are released to rise to the top of the tank, infusing the liquid in the tank with air.

### BACKGROUND

Many chemical and biological systems require that a gas be transferred into a liquid. One example is the bubbling of air up through wastewater tanks in water treatment plants. Another is spraying wastewater into the air above a treatment pond. Both approaches increase the surface contacts between the wastewater and the air. The bubbling process creates small air bubbles with high surface area in contact with the surrounding water. The spraying process creates many droplets with high surface area that are in contact with the surrounding air. The contact between the air and wastewater transfers oxygen across the air-water surface. The oxygen transfer into the wastewater supports the microbial life forms that consume and convert the biological and chemical materials in the wastewater.

Many of these methods involve high energy use for a given transfer of oxygen to the liquid. The spraying approach uses low energy pumping on the surface but does not transfer as much oxygen to the wastewater as bubblers placed at the bottom of the tank. However, equipment producing bubbles at the bottom of the tank, typically consumes more power than surface spraying equipment, but results in more oxygen diffused into the water per unit of energy consumed by the equipment. The balance of energy use and cost with the rate of oxygen transfer to the wastewater often has a strong influence on the type of system deployed.

The bubbler systems also provide some mixing of the materials in the tank as the bubbles create rising currents in the water. This helps prevent sedimentation of the biological materials, which can restrict access to the beneficial microbes in the tanks and result in incomplete processing of the wastewater.

For many wastewater treatment operations, bubblers placed at the bottom of the tank are of several types called air diffusers. This is often the preferred alternative as it transfers more oxygen into the tank at lower energy use and with lower operating and maintenance costs than other systems. Typically several diffusers are placed in a grid pattern near the bottom of the tank to ensure that rising air bubbles reach all parts of the tank. The grid of diffusers is connected to a compressed air piping system. Powerful compressors are installed to supply air to the piping and attached diffusers.

A widely used diffuser system is referred to as a fine bubble diffuser, which forces air through a finely divided membrane or disk and produces bubbles at a size of 2-3 millimeters in diameter. The small size of the bubbles creates more surface area per volume compared to larger bubbles. These small bubbles rise at a speed of about 30 centimeters per second, or 40 feet per minute. This rate of rise is dependent on the buoyancy of the bubble and the friction of the water on the surface of the bubble as the bubble moves up through the water. As the bubbles move up, the friction imparts a force on the surrounding water, creating upward movement of the surrounding water. The upward movement of the bubbles and surrounding water help to give upward momentum to any biological material suspended in the water and helps prevent sedimentation in the tank.

The compressors must overcome the pressure of the wastewater at the submerged depth of the diffuser in the tank, as well as the pressure required to push air through the diffuser air openings, and the pressure to distribute the air through the piping grid to the diffusers. With air flows measured in thousand of cubic feet per minute and pressures at around 8 pounds per square inch for a 16 foot deep tank, the compressor power consumption will often be in the hundreds of horsepower and compressor energy costs will often be over $100,000 per year. Several studies report that aeration energy costs are 50 percent or more of all the energy expense in a waste water treatment plant.

There are other disadvantages to use of the fine bubble diffusers installed at the bottom of the tank. These include: 1) fouling of the small openings of the diffusers, which blocks air flow, reduces capacity, and requires increased air pressure and compressor energy use to maintain air flow rates, 2) cleaning of the diffusers, which is required at regular intervals and requires emptying the tank, hosing off the diffuser, brushing the surface clean, 3) sediment forms on the top face of the diffuser when air flow is stopped and materials in the water above settle on the diffuser face below, 4) location of the diffusers near, but not on the bottom, which means that solids can accumulate on the bottom of the tank in the spaces below the level of the diffuser face and will not see the upward flow of water and bubbles to keep the materials suspended and available to the microbes in the tank, 5) failure of a diffuser by having a membrane tear open or other failure that allows air to rapidly exit the diffuser or piping, results in the pressure in the surrounding grid of pipes and diffusers dropping and air flow being reduced or eliminated in that area of the tank, requiring the expense and impact on operations of having to drain the tank and repair the unit, 6) the large number of diffusers spread evenly across the entire tank bottom create considerable expense in the cost of piping and fittings and installation, 7) the bubbles emitted from the bottom of the tank will rise to the surface and will only be in contact with the surrounding wastewater for the time it takes to rise up from the depth of the tank, and 8) once the bubbles are formed at the pressure at the bottom of the tank, they increase in size and volume as they rise through the lower pressure areas higher up in the tank, causing the bubble rise to accelerate.

The current invention uses an alternate approach to the traditional method of placing fine bubble diffusers at the bottom of the tank, by placing the fine bubble diffusers up at a level at, or near the surface of the wastewater in the tank. Wastewater is pumped from the surface, over the top of the diffusers. The wastewater and the entrained bubbles from the diffusers then flow back into return pipes which flow back down into the tank and disperse the liquid and bubbles across the bottom of the tank. By containing the diffusers in a trough or pipe that contains wastewater pumped from the height of the surface of the tank, to just sufficient depth to minimally cover the diffusers, the air pressure required to produce the bubbles is greatly reduced, compared to the pressure required to produce bubbles at the bottom of the tank. The reduced pressure reduces the energy use of the compressor to produce the same volume of bubbles.

With the use of diffusers under a shallow water level and high volume low pressure pumps, the total combined pumping and compressor energy is less than the energy required for aeration using floor mounted diffusers. Such high volume low pressure pumps can be located at any depth in the tank to help reduce undesirable cavitation and erosion of the pump components. However, the work involved in pumping the water from the tank to the diffusers in the trough will be primarily a function of the volume of the flow and difference between the height of the water at the surface of the tank and the height in the trough above the diffusers. As a result, increasing depth in the tank has minimal impact on the energy required for aeration using the present invention, compared to a significant increase in energy required for a bottom mounted diffuser placed at increasing depth.

The present invention, with the diffuser location at of above the top of the tank provides a convenient location to access the diffusers for cleaning, replacement, or repair, without having to empty the tank. For example, if the diffusers are installed in a covered trough, on the ground, just at the side of the tank, the cover could be simply raised to provide access to any diffuser. Shutting off the pumped flow would quickly drain the trough leaving the diffuser accessible for maintenance by personnel standing beside the trough. The present invention moves the diffusers into a very shallow water column, which, by virtue of its shallow depth, will not contain large amounts of suspended materials, reducing the amount of material that could settle on the diffuser top face when aeration stops. Reduced settling of material on the diffusers will help maintain diffuser air flow and low aeration energy use.

The present invention enables the air and water bubbles returning to the tank to be directed to any and all locations of the tank bottom by directing the outflow from the returning water pipes to areas that would be prone to sedimentation. This prevents sediment building up on the floor of the tank and improves suspension of all biological materials in the tank to accelerate and more thoroughly complete processing.

The present invention reduces the impact of a failed diffuser at the tank bottom on the even distribution of air across the system by enabling rapid repair or replacement of the diffuser without having to drain and clean the tank for access, before refilling the tank to restart aeration.

The present invention reduces the amount of piping required for distribution of the diffusers, reducing capital costs. This is made possible by placing the diffusers in tightly spaced rows near to the top of the return pipes which lead down to the tank. Diffusers may also be stacked vertically one above the other as the pumped water carries the bubbles horizontally across the face of the diffuser and into the return pipes leading back to the tank. The close spacing of the diffusers reduces the amount of pipe required to achieve equivalent air flow into the tank. The low pressure of the air in the pipes at or near the surface allows the pipes to be of weaker construction and lower cost than pipes which have to withstand the pressure at the bottom of the tank when air flow stops and the air pressure inside the pipe reverts to atmospheric pressure.

The present invention uses the flow of water to drive the bubbles from the diffuser, into the return pipes and down into the tank. The amount of time the bubbles are submerged, and the amount of water that passes over the surface of the bubble are increased compared to bubbles that emerged from a diffuser at the bottom of the tank and rise to the surface. The added time and contact will increase the transfer of oxygen into the water compared to bubbles from the bottom mounted diffuser that have shorter time immersed with less flow of water over the bubble surface.

The present invention forms bubbles at a low pressure near the surface of the tank. For a given pressure drop across a specific diffuser face the bubble diameter is constant. So, a bubble formed by a 0.25 pound per square inch pressure drop across a diffuser will be the same size whether formed at 1 foot depth of water near the top of the tank or in 16 feet of water at the bottom of the tank. For the diffuser at the bottom of the tank, which produces 2 millimeter (mm) diameter bubbles, the bubbles will rise to the surface, and be 2.23 millimeters in diameter at the surface. When a diffuser near the surface makes the same bubble of 2 mm diameter, then the bubble is transported to a higher pressure at a depth of 16′ at the bottom of the tank, the bubble diameter is reduced to 1.8 mm. This small change in bubble diameter, when released at the bottom of the tank, results in a slower rise by about 2 feet per minute, and about a 10% longer time to transfer oxygen to the water than for the bubble of 2 mm size formed and released from the diffuser at the bottom of the tank.

### DESCRIPTION OF THE DRAWINGS

FIG. 1 is a side view of a system,

FIG. 2 is a plan view of the system.

FIG. 3 shows a side view of 3 vertically stacked diffusers in a trough

### DETAILED DESCRIPTION OF A PREFERRED EMBODIMENT

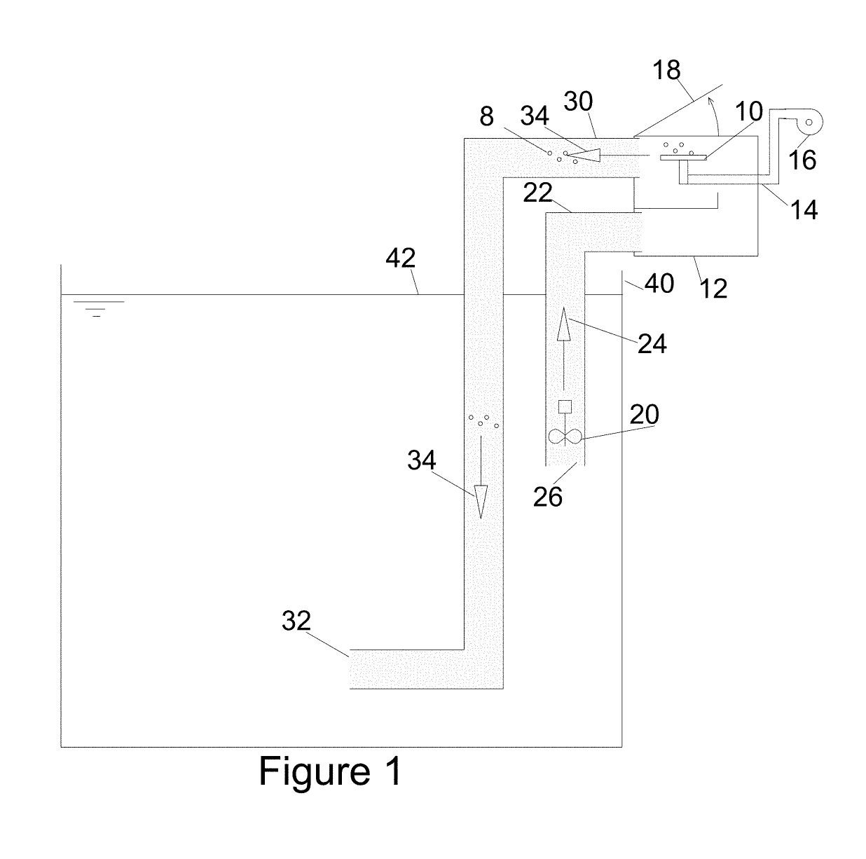

The low energy aeration system is shown in FIG. 1. Fine bubbles 8 are emitted from a fine bubble diffuser 10 which is shown in a trough 12. Air piping 14 connects the diffuser to a low pressure blower 16 which draws air from the atmosphere and supplies air to the diffuser at a pressure of about 1 pound per square inch (PSI).

Within the tank 40, filled to a level 42, is a low pressure high volume pump 20 connected to a pipe 22 which leads up to and is connected to the trough 12 at the top of the tank. Water or wastewater 24 is pumped up from the tank through an inlet 26 to the pump, and into the trough 12 completely filling the trough above the surface of the diffuser 10.

When the pump is running and the blower is energized, fine bubbles are formed at the top face of the diffuser and are released into the flowing water in the trough. As the water flows across the face of the diffuser, and into the return pipe, the bubbles are carried into the flow. The pumped water in the trough with the entrained fine bubbles 34 then returns to the tank via a return pipe 30 to an outlet 32.

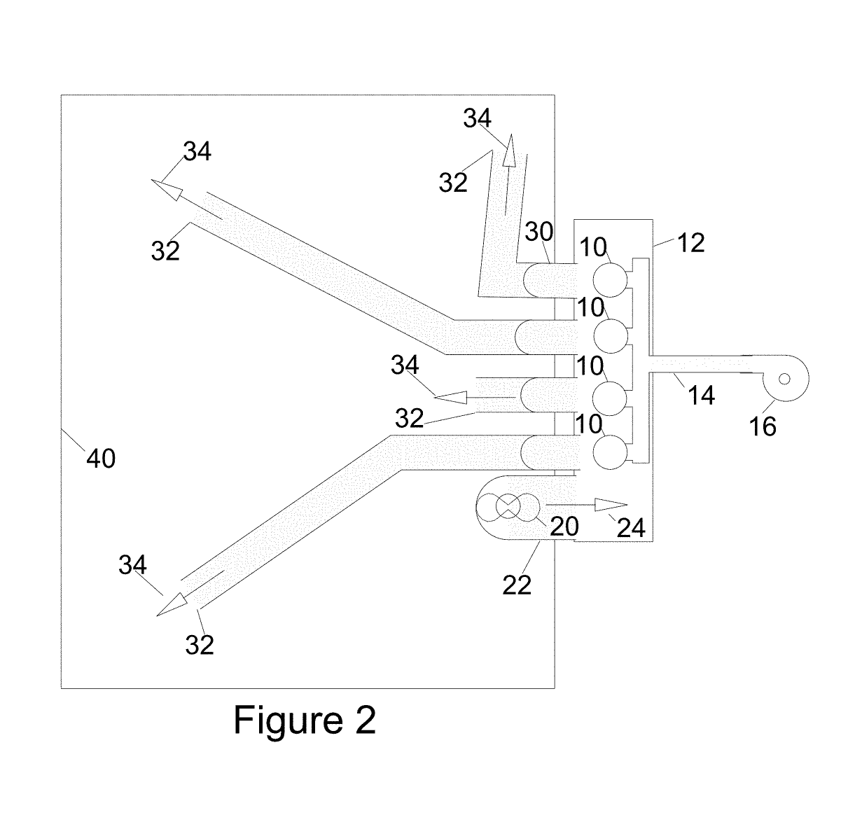

FIG. 2 shows a plan view of several diffusers 10 connected to air piping 14 supplied with air from a low pressure blower 16. The diffusers are located in a trough 12. Water or wastewater 24 from the tank 40 is pumped by pump 20 up the supply pipe 22 into the trough. Water flows across the diffusers and the air bubbles from the diffusers becomes entrained with the water. This air bubble-water mixture 34 flows into several return pipes 30 which turn down to the bottom of the tank and the mixture exits through outlets 32 at the end of each pipe, which are arranged to cause the aerated water mixture to flow in various directions across the bottom of the tank 40.

If the bubble diameter is 2 mm, the rate of rise of the bubble by buoyancy is about 40 feet per minute. By providing a flow of water in the return pipe vertical leg that is moving faster than 40 feet per minute, the bubbles will be carried down to the bottom of the tank. In a preferred embodiment, a water flow rate of 80 feet per minute will move the bubbles down the return pipe to the outlet 32 at about 40 feet per minute. In the preferred embodiment, the volume of water flowing down the return pipe would be about 4 times the volume of air produced by the diffuser, resulting in an air volume fraction of 20% in the return pipe. In the preferred embodiment, 4 cubic feet of water would be pumped across the diffusers and down the return pipe for every cubic foot of air bubbles released and the return pipe would have a cross section area sufficient to maintain the air and water flow at an initial water speed of 80 feet per minute at the top of the vertical leg of the return pipe.

When the bubble size created at the diffuser is less than 2 mm, the rate of rise of the bubble in the open tank is slower than for bubbles 2 mm or larger. This slower rate of rise allows the water flow rate in the return pipe to be slower while still carrying the bubbles down the return pipe. In one preferred embodiment, the bubble size of 1 mm would have a rate of rise of 30 feet per minute and the initial water flow speed could be reduced to 70 feet per minute to achieve the same speed down the return pipe. This requires 12.5% less pumping required to achieve the same transfer of air to the bottom of the tank as is required for a 2 mm bubble size.

Several varied methods of producing the fine bubbles exist. In the preferred embodiment, a membrane diffuser, such as the Sanitaire membrane disc diffuser, can create 2 mm bubbles with a pressure drop across the diffuser of 0.6 pounds per square inch. In the preferred embodiment, with several diffusers connected to a network of air distribution piping, the total pressure drop from the blower inlet to the top face of the diffuser in the trough would be about 1.50 pounds per square inch. A blower or fan, can produce over 2300 cubic feet per minute of air flow at 1.5 pounds per square inch and with a power consumption of 30 horsepower. Water flow at the preferred water to air ratio of 4 to 1 would be 9200 cubic feet per minute, or 69,000 gallons per minute. Pumping the water up from the tank surface to the trough at a height of 3.5 feet above the surface, would require only 85 horsepower using a low head, high volume propeller pump, such as an FPI AF72-60-185 model. So, total power for this system would be 115 horsepower for 2,300 cubic feet of air delivered to the bottom of the tank.

In comparison, a conventional bottom mounted diffuser and high pressure compressor, supplying 2,300 cubic feet of air to diffusers mounted 16 feet below the surface at a total system pressure of 7.8 pounds per square inch, would require approximately 150 HP based on a Hoffman and Lamson 741 series compressor with 5 stages of compression. Any additional depth of the wastewater as might occur in a deeper tank, would raise the required compressor pressure and require about 20 additional horsepower for every 2 feet of depth. In contrast, the present invention would see no increase in horsepower for the pump or blower as the pump pressure remains the same from the surface to the top of the trough and the blower pressure remains the same from the blower inlet to the top of the diffusers.

In the preferred embodiment, the top of the trough would have a cover 18 that could be opened for access to the diffusers. The cover could be hinged and capable of being locked down when wastewater is pumped over the diffusers. When there are signs of a diffuser failure, such as large diameter bubbles rising from the bottom of the tank, low bubble volume rising to the top of the tank, or low bubble volume in the water flow to the tank due to high air volume at the top of the trough and low water level in the trough, the pumping can be stopped and the cover lifted to provide easy access to repair or replace the failed diffuser or piping.

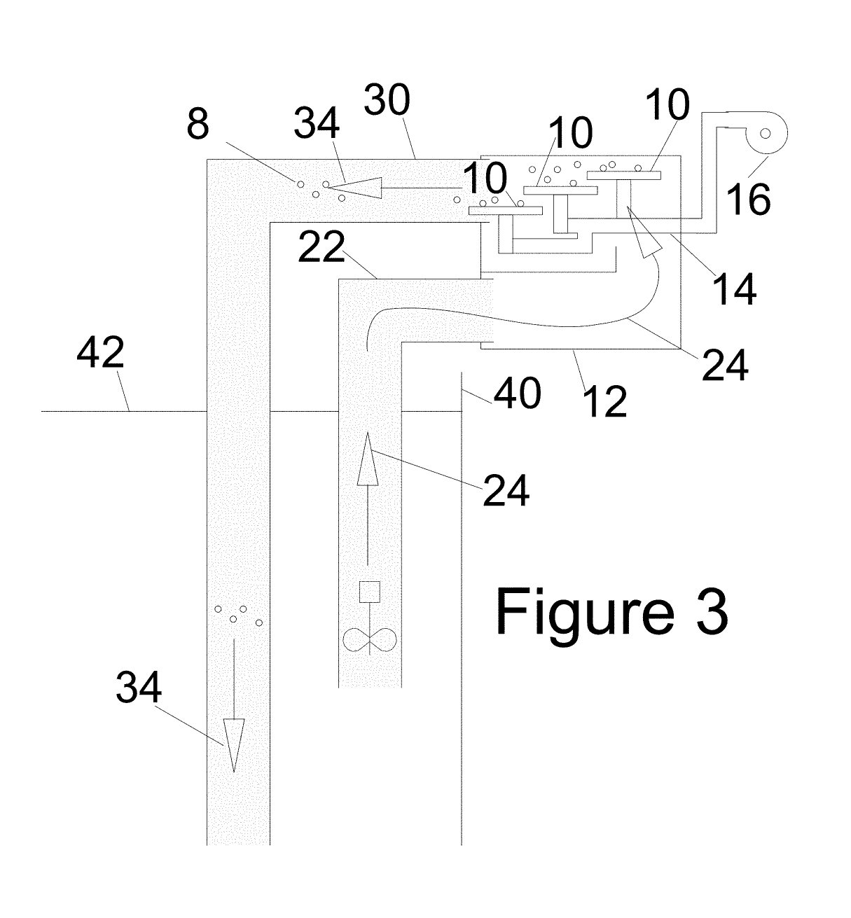

In the preferred embodiment shown in FIG. 3, diffusers 10 can be stacked vertically above the area of the lower diffusers. Because the pumped wastewater flow 24 in the trough is nearly horizontal across the face of the diffusers 10, the bubble path leaving the diffuser 10 in the air bubble-water mixture 34 and moving to the return pipe 30 is nearly horizontal. At the bottom of the tank, the distribution of the air bubble-water mixture occurs by arrangement of the return pipe outlets 32. As a result, the same number of diffusers required for aeration when mounted in a grid on the bottom of the tank, can be confined to a smaller area in the trough. This includes stacking the diffusers vertically above one another or partially overlapping. This reduces the amount of air piping 14 required in the preferred embodiment to achieve the same air flow into the wastewater 24 as the distributed bottom mounted diffusers.

With the present invention, when aeration stops, and the pump stops, the water in the trough can flow back into the tank and uncover the diffuser top surfaces in the trough. This eliminates the potential for sedimentation on the diffuser face from a large quantity of suspended biological material in a tall water column above the diffuser, as would be found in a bottom mounted diffuser below several feet of wastewater.

With the preferred embodiment shown in FIG. 2, the return pipes would terminate near the bottom of the tank with several pipes directing the flow of aerated water 34 to various locations across the tank. This will ensure that the water and air bubbles scour across all the bottom of the tank to prevent sedimentation in any one area, maintain all biological material in suspension in the tanks to maximize contact with the air in the water, and widely distribute the air in the tank. Even if the pumping is stopped, and sedimentation occurs, restarting the pump will scour the floor again and re-suspend the sediment. This is unlike the operation of the bottom mounted air diffusers, which may have sediment form below the level of the diffuser that will never see sufficient water flow to re-suspend the particles trapped in the sediment.

In the preferred embodiment, the time the bubbles are in contact with the wastewater will be increased by virtue of the longer path from the diffuser, down in the return pipe, and rising up from the return pipe outlet at bottom of the tank. This more than doubles the distance that the bubbles are in contact with the wastewater compared to the bubbles from the bottom mounted diffusers. In addition, the water flow over the surface of the bubbles in the vertical section of the return pipe will be substantially greater than the water flow from a bubbles freely rising through the same distance in the open tank, with a volume of entrained wastewater water flowing up with the bubbles due to a momentum transfer from the bubbles to the surrounding wastewater. The combination of longer distance submerged and time spent in counter flow to the water in the vertical leg of the return pipe, substantially increases the air to water surface contact compared to bubbles formed and released at the bottom of the tank.

In another preferred embodiment, the bubbles created in the trough will be 2 millimeters in diameter. As the bubbles are carried to the bottom of the tank they are subjected to greater hydrostatic pressure and shrink in volume and diameter. A 2 millimeter bubble formed in the trough will become 1.8 millimeters when exiting the return pipe outlet in 16 feet of wastewater. These smaller bubbles rise more slowly from the bottom of the tank, than do 2 millimeter diameter bubbles formed at the bottom of the tank by a bottom mounted diffuser. The bubbles of the present invention will return to 2 millimeters at the surface and atmospheric pressure. In comparison, a bubble formed in a bottom mounted diffuser under the same pressure across the diffuser surface will be 2 millimeters in diameter when formed and grow to 2.2 millimeters in diameter when at the surface. With the present invention, the smaller bubble size, over the entire rise period, from bottom to surface, results in a slower rise speed and increases the time for oxygen transfer to the wastewater.

The preferred embodiment described above represents one set of arrangements and equipments to provide an aeration system with lower energy use than traditional aeration with bottom mounted air diffusers. It will be apparent to those skilled in the art that there are other combinations of equipments and arrangements that can be applied to the preferred embodiment to provide the same innovative benefits of lower energy use, improved maintainability, and simpler operations than the bottom mounted air diffuser. Such alternatives could include bubble producing equipment that uses; jet aerators, micro-bubble aerators, and aspirating mixers, to name a few. Similarly, the preferred embodiment could locate the air diffusers inside the tank at the surface, or slightly above the surface, or just below the surface. The diffusers could be stacked vertically or in single rows with one or more return pipes serving multiple diffusers. In addition, air diffusers which produce smaller bubble sizes with slower rise rates than those described in the preferred embodiment could be used to slow the required return pipe speed and reduce the flow of water and the power required for pumping. All manner of piping, pumping, water flow, and venting arrangements are also possible. All these are obvious to a person skilled in the art.

1. A system to aerate a liquid in a tank comprising:
a compressor supplying compressed air to bubble aerators located near a top of the liquid in the tank, a pump moving the liquid from the tank over the bubble aerators to entrain bubbles in the liquid to form a bubble and liquid mixture, and a downflow path with limited cross section for conveying the bubble and liquid mixture from the bubble aerators to a bottom of the tank at a speed greater than the bubbles can rise in the mixture.

2. An apparatus for minimizing energy use in aeration of a tank of liquid comprising:
a compressor supplying compressed air to bubble aerators located near a top of the liquid in the tank, a pump moving liquid from the tank over the bubble aerators to entrain bubbles in the liquid to form a bubble and liquid mixture, and an enclosed downflow path with limited cross section for conveying the bubble and liquid mixture from the bubble aerators to the bottom of the tank at a speed greater than the bubbles can rise in the mixture.

3. An apparatus for minimizing maintenance and repair time in aeration of a tank of liquid comprising:
a compressor supplying compressed air to bubble aerators located near a top of the liquid in the tank, a pump moving liquid from the tank over the bubble aerators to entrain the bubbles in the liquid to form a bubble and liquid mixture, and an enclosed downflow path with limited cross section for conveying the bubble and liquid mixture from the bubble aerators to a bottom of the tank, such that access to the bubble aerators is located near the top of the liquid.

4. The apparatus of claim 2 wherein minimal energy is used to operate the compressor due to low required pressure of the bubble aerators operating at shallow depth near the top of the liquid.

5. The apparatus of claim 2 wherein minimal energy is used to operate the compressor by maintaining the bubble aerators in clean condition due to continuous pumping of the liquid across a surface of the bubble aerators.

6. The apparatus of claim 2 wherein minimal energy is used to operate the compressor by reducing undesired increased air flow from damaged bubble aerators by enabling rapid repair due to easy access to the damaged bubble aerators located near the top of the liquid.

7. The apparatus of claim 2 wherein minimal energy is used to operate the compressor by reducing air volume required due to the production of smaller bubbles at the bottom of the tank than are produced at the bubble aerators, resulting in a slower rise time of bubbles in the tank and more complete aeration of the liquid.
